(19) United States
(12) Patent Application Publication
(10) Pub. No.: US 2009/0162528 A1
(43) Pub. Date: Jun. 25, 2009

(54) Fruit sugar product and method of making the same

(76) Inventor: Sara Mayer, New York, NY (US)

Correspondence Address: RICHARD B. KLAR, 145 WILLIS AVENUE, SUITE NO. 6, MINEOLA, NY, 11501, US

(21) Appl. No.: 12/004,879

(22) Filed: Dec. 24, 2007

(51) Int. Cl. A23L 1/064

(52) U.S. Cl. 426/639

(57) ABSTRACT

A fruit sugar product and a method of making it by first preparing a real fruit and preferably an organic fruit for dehydration. The fruit is then dehydrated by use of either an oven or an electric food dehydrator. The dehydrated fruit is then ground together with sugar to obtain a natural fruit sugar product.

### BACKGROUND

Sugar is widely used in as an ingredient for many food products and in baking many items such as cookies, pastry and cakes and pies.

It would be desirable to make a sugar that has fruit in it to provide a fruit sugar product that can be eaten or used as ingredient in many products such as those noted above. It would further be desirable to make a fruit sugar product that can be used in a variety of fruit flavors including but not limited to blackberry, blueberry, peach, raspberry and strawberry and which can be used in one's favorite cereal or oatmeal or on waffles, pancakes, french toast or in a cup of tea.

### SUMMARY

The present disclosure relates to a fruit sugar product and a method for making the same.

The present disclosure relates to a fruit sugar product and a method for making a fruit sugar product.

The present disclosure provides for the use of real fruit, which is combined with sugar to create a fruit sugar product.

The present disclosure provides for a fruit sugar product combining sugar with dehydrated natural fruit that are ground together to make a sugar product that is flavored with natural fruit and has fruit chunks in it.

### BRIEF DESCRIPTION OF THE DRAWING

FIG. 1 is a flow chart illustrating the preparation of the fruit sugar product in accordance with the present disclosure.

### DETAILED DESCRIPTION OF THE PREFERRED EMBODIMENTS

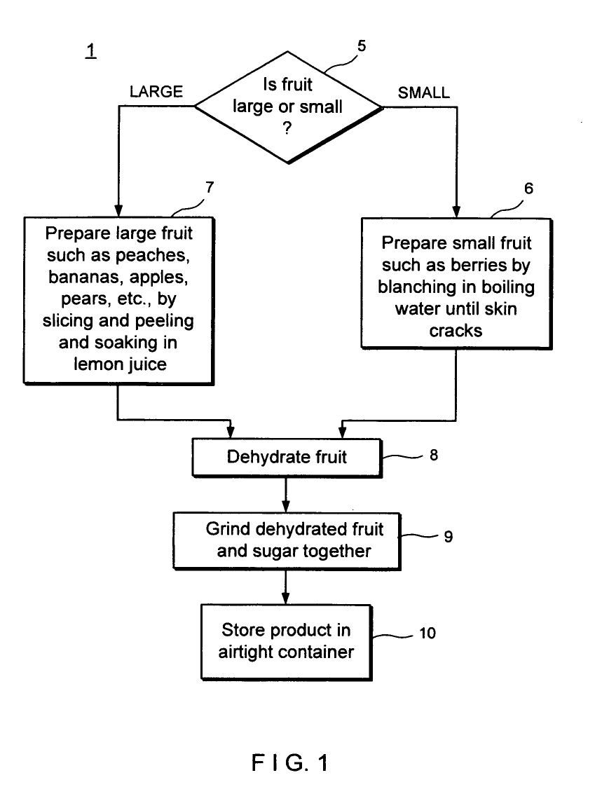

Referring to the drawing, FIG. 1 shows a flow chart detailing the steps for preparing a fruit sugar product and the method for so doing in accordance with the present disclosure. The fruit used will be real fruit and preferably organic fruit. The fruit sugar product 1 is prepared by first determining (5) if large or small fruit is to be used. If large fruit is used such as by way of non- limiting examples peaches, bananas, apples pears, etc. These fruit are sliced and peeled and then soaked in lemon juice to prepare those (7) for dehydration (8).

If small fruit is used, such as by way of non-limiting example berries, then the small fruit is prepared for dehydration by blanching this fruit in boiling water until the skin of the fruit cracks (6).

Once the large or small real fruit and preferably organic fruit are prepared, the prepared fruit is then dehydrated (8). Dehydration in step 8 may be done preferably in one of two ways. The first way is for the fruit to be placed in an oven by first putting the fruit into trays and then placing the trays into the oven. The oven is preferably set to a low temperature of 120 to 140 degrees. In the oven the fruit dehydrates for anywhere from 12-48 hours. The door should be propped open for proper air circulation, the fruit is dry when one can tear the fruit and no moisture appears.

The second way for dehydration of the fruit (8) is by using an electric food dehydrator and this is the preferable method of the two. The prepared fruit is placed on trays in the dehydrator. Drying can take anywhere from 4-24 hours.

It is understood that the present disclosure is not limited to these two ways of dehydration and alternative ways for dehydrating the fruit can be used.

The dehydrated fruit is stored in airtight containers before use.

The sugar used can be granulated sugar or any other commercially known sugar such as superfine sugar, granulated sugar, natural sugar or brown sugar. The sugar and the dehydrated fruit are then ground together (9) in one of two ways.

The dehydrated fruit and sugar can be ground together by hand in a mortar and pestle. Grinding should be between 2-10 minutes in ¼ cup or larger quantities. It is preferable to leave small chunks of fruit in the sugar.

Alternatively a food processor can be used for grinding (9) where the sugar to fruit ratio is anywhere from 2 to 1 to 4 to 1 or larger depending on the fruit (for example 4 cups to 2 cups to 4 cups to 1 cup) and the sugar and dehydrated fruit are pulsed together anywhere from 30 seconds to 4 minutes leaving chunks of fruit.

The stored fruit sugar product is stored in airtight containers (10).

The result is sugar that is flavored with natural and preferably organic fruit and has chunks of fruit in it. This fruit sugar product can be used in baking such as for cakes, cookies, and for flavoring a variety of foods such as cereal, oatmeal or on waffles, pancakes, french toast or in a cup of tea or other drink.

While presently preferred embodiments have been described for purposes of the disclosure, it is understood that numerous changes in the arrangement of apparatus parts can be made by those skilled in the art. Such changes are encompassed within the spirit of the invention as defined by the appended claims.

What is claimed:

1. A method of making a fruit flavored sugar product, the steps, comprising:
preparing a real fruit for dehydration;
dehydrating the prepared fruit; and
grinding together the dehydrated prepared fruit and sugar; to obtain a fruit sugar product.

2. The method according to claim 1 wherein the preparing step includes slicing and peeling fruit when said fruit is a large type of fruit and then soaking the sliced and peeled fruit in lemon juice.

3. The method according to claim 1 wherein the preparing step includes blanching the fruit in boiled water until the skin cracks when said fruit is a small type of fruit.

4. The method according to claim 1 wherein the dehydrating step includes placing the prepared fruit into a tray and placing the trays into an oven set for a temperature of approximately 120 to 140 degrees from approximately 12 to 48 hours.

5. The method according to claim 4 wherein the dehydrating step further includes propping open the door of the oven for proper air circulation.

6. The method according to claim 4 wherein the dehydrating step further includes checking when the fruit is dry when the fruit can be torn and no moisture appears.

7. The method according to claim 1 wherein the dehydrating step includes placing the fruit in trays and placing the trays into an electric food dehydrator from approximately from 4-24 hours.

8. The method according to claim 1 wherein the grinding step includes grinding the dehydrated fruit and the sugar together by a mortar and pestle.

9. The method according to claim 8 wherein said mortar and pestle grind said sugar and dehydrated fruit together by grinding for approximately 2-10 minutes in ¼ cup quantities in a ratio of anywhere from 2 to 1 to 4 to 1 (for example 2 cups to 1 cup to 4 cups to 1 cup) of fruit to sugar.

10. The method according to claim 9 wherein said grinding step includes grinding the sugar and fruit together only so fine as to still leave chunks of fruit in the sugar.

11. The method according to claim 1 further comprising the step of storing the dehydrated fruit in one or more airtight containers until ready to grind the dehydrated fruit with the sugar.

12. The method according to claim 1 further comprising after the grinding step, the step of storing the fruit sugar product in one or more airtight containers.

13. A fruit flavored sugar product, comprising:
dehydrated real fruit and sugar ground together to form a natural fruit sugar product.

14. The product according to claim 13 wherein said natural fruit sugar product includes chunks of real fruit therein.

15. The product according to claim 13 wherein said fruit is an organic fruit.

16. The product according to claim 13 wherein the fruit is a large type of fruit and is peeled and sliced and soaked in lemon juice prior to being dehydrated.

17. The product according to claim 13 wherein the fruit is a small type of fruit and it is blanched in boiling water until the skin cracks prior to being dehydrated.
